(19) United States
(12) Patent Application Publication
(10) Pub. No.: US 2011/0236644 A1
(43) Pub. Date: Sep. 29, 2011

(54) SYSTEMS AND METHODS FOR FORMING IMAGES ON CEMENT FIBER BOARD MATERIALS AND OTHER SURFACES

(76) Inventor: Gilbert Garitano, Alameda, CA (US)

(21) Appl. No.: 12/671,661

(22) PCT Filed: Aug. 4, 2008
(86) PCT No.: PCT/US2008/072128

§ 371 Date: May 11, 2010

Related U.S. Application Data
(60) Provisional application No. 60/953,880, filed on Aug. 3, 2007.
(60) Provisional application No. 60/992,361, filed on Dec. 5, 2007.

(51) Int. Cl. B32B 3/10; B41F 33/00; B32B 27/30

(52) U.S. Cl. 428/195.1; 101/483; 428/500

(57) ABSTRACT

The present invention relates to systems and methods for forming images in surfaces, and to surfaces. In particular, the present invention provides systems and methods for forming images in decorative surface materials, and decorative surface materials containing an image with novel optical density characteristics. In some embodiments a liquid acrylic resin is applied to a surface prior to image transfer. In some embodiments, a primer is applied to a surface material prior to forming images in the surface, with or without combined application of a liquid acrylic resin.

The present application claims priority to U.S. Provisional Application Ser. No. 60/953,880, filed Aug. 3, 2007, and U.S. Provisional Application Ser. No. 60/992,361, filed Dec. 5, 2007, both of which are herein incorporated by reference in their entireties.

### FIELD OF THE INVENTION

The present invention relates to systems and methods for forming images in surfaces, such as cement fiber board, and to surfaces. In particular, the present invention provides systems and methods for forming images in decorative surface materials, and decorative surface materials containing an image with novel optical density characteristics. In some embodiments, a liquid acrylic resin is applied to a surface prior to image transfer. In some embodiments, a primer is applied to a surface material prior to forming images in the surface, with or without combined application of a liquid acrylic resin. In other embodiments, an image is applied to a transfer paper comprising clay wherein said transfer paper is then applied to the surface material for transferring the image to the surface.

### BACKGROUND OF THE INVENTION

Decorative surface materials are well known in the art, and have achieved nearly ubiquitous commercial and non-commercial use, particularly in the furniture, interior design, construction, craft, and printing industries. Such surface materials are disclosed, for example, in U.S. Pat. No. 6,759,105 to Brooker et al. Many such materials are useful as visible decorative layers in composite materials such as laminates. In decorative laminate materials, a visible decorative surface is bonded, usually via the application of heat and/or pressure, to one or more layers of one or more different materials with desirable properties, such as low cost, strength, durability, and/or high availability. For example, a common decorative laminate product is a composite material that simulates the look and/or feel of solid wood. Such products are in widespread use in articles such as furniture, flooring, decorative wall paneling, interior or exterior vehicle trim, and home decor items. Other common decorative laminate products include composite materials that simulate materials such as marble, stone, metal, and ceramics. Because decorative surface materials, such as the type used in laminates, are typically produced by creating a decorative image within or upon a suitable surface medium, the ability to satisfactorily reproduce the decorative image within or upon the surface medium is of paramount importance. The quality of the reproduced image is directly related to the aesthetic quality of the final product. Unfortunately, many surface media are resistant to the creation and/or retention of high quality images within or upon them. Thus, the art is in need of systems and methods for adding vivid color and detailed images to decorative surface materials.

### SUMMARY OF THE INVENTION

The present invention relates to systems and methods for forming images in surfaces, and to surfaces. In particular, the present invention provides systems and methods for forming images in decorative surface materials, and decorative surface materials containing an image with novel optical density characteristics. In some embodiments, a liquid acrylic (or powder acrylic) resin is applied to a surface prior to image transfer. In some embodiments, a primer is applied to a surface material prior to forming images in the surface, with or without combined application of a liquid or powder acrylic resin. In other embodiments, an image is applied to a transfer paper comprising clay wherein said transfer paper is then applied to the surface material for transferring the image to the surface.

The present invention relates to systems and methods for forming images in surfaces, and to surfaces. In particular, the present invention provides systems and methods for forming images with novel optical properties in materials used in covering floors and walls. In some embodiments, a liquid acrylic resin is applied to a surface prior to image transfer. In some embodiments, a primer is applied to a surface material prior to forming images in the surface, with or without combined application of a liquid acrylic resin.

In certain embodiments, the present invention provides compositions comprising a backer board (cement fiber board) and an image transferred to the backer board (e.g., into a clear acrylic resin layer on the backer board). In other embodiments, the present invention provides methods of creating an image on a backer board comprising: a) a backer board, b) an image, and c) transferring the image onto the backer board thereby creating an image on a backer board.

In some embodiments, the present invention provides methods for printing an image onto a surface material, comprising: a) providing: i) cement fiber board material (or other material such as wood, aluminum or other metal, plastic, or other material) comprising a surface; and ii) a transfer medium comprising a transfer image, b) coating the surface of the cement fiber board material (or other material) with a clear acrylic resin to create a clear acrylic resin layer on the surface, and c) contacting the clear acrylic resin layer with the transfer medium such that a fixed image is formed in the clear acrylic resin layer to create a printed surface on the cement fiber board material. In certain embodiments, the clear acrylic that is applied comprises about 1% 2-Methoxymethylethoxypropanol and about 3% 1-(2-Butoxymethylethoxy)-propanol.

In certain embodiments, the cement fiber board material comprises about 10% cellulose fiber and about 90% cement (e.g., Portland cement). In other embodiments, the cement fiber board comprises Portland cement, flay ash, and wood fiber.

In certain embodiments, the method further comprises, prior to step b), a step of coating the surface of the cement fiber board material (or other material) with an opaque primer. In particular embodiments, the opaque primer is a heat-stable primer. In particular embodiments, the heat-stable primer is able to withstand temperatures of between 230 and 390 degrees Fahrenheit without bubbling (e.g., between 240 and 350 degrees Fahrenheit, or between 250 and 330 degrees Fahrenheit). In other embodiments, the heat stable primer is able to withstand a temperature of at least 200 degrees Fahrenheit without bubbling (e.g., at least 220 . . . 250 . . . 280 . . . 300 . . . 330 . . . 350 . . . or 400 degrees Fahrenheit). In certain embodiments, the heat stable primer is BENJAMIN MOORE FRESH START all purpose primer or a similar primer. In other embodiments, the heat stable primer is one of AREMCOS CORR-PANT protective coatings (e.g., CORR-PANT CP2000 series, CP3000 series, CP4000 series, or CP5000 series), or a similar primer. In other embodiments, the heat stable primer is WEATHERKING brand primer, Kem® Hi-Temp Heat-Flex® II 450 primer, Pyro-Paint™ primer, Thurmalox® primer,

In some embodiments, the methods further provide a top plate (e.g., top platen) and a bottom plate (e.g., bottom platten), and wherein the contacting is conducted under pressure between the top plate and the bottom plate (e.g., using a heat-press, or a double heat press). In certain embodiments, the method comprise providing a compressible layer, wherein the compressible layer is situated between the top plate and the bottom plate. In some embodiments, the compressible layer is made of rubber, synthetic rubber, heat resistant foam-like material, deformable plastic, or other material that may be compressed under pressure. In additional embodiments, the compressible layer is in contact with the transfer medium.

In certain embodiments, the contacting is conducted under heat and/or pressure. In particular embodiments, the pressure is at least 5 pounds per square inch (e.g., 8, 10, 15 or 20 pounds of pressure per square inch). In some embodiments, the pressure is at least 30 pounds per square inch (e.g., at least 30, 35, 40, 45, or 50 pounds of pressure per square inch). In other embodiments, the pressure is about 45 pounds per square inch (e.g., 40, 41, 42, 43, 44, 45, 46, 47, 48, 49, or 50 pounds of pressure per square inch). In certain embodiments, the pressure has a range of 1-250, 10-100, 20-60, 30-50, or 35-50 pounds of pressure.

In certain embodiments, the methods further comprise providing at least one moisture absorbing layer, wherein the at least one moisture absorbing layer is situated between the top plate and the bottom plate. In particular embodiments, the moisture absorbing layer is paper (e.g., kraft paper), a dessicant material, a sponge material, water absorbing wood or plastic material (e.g., a sawdust based product), or any other suitable material that is able to absorb water moisture. In some embodiments, the methods further comprise providing a compressible layer and at least one moisture absorbing layer, wherein the compressible layer and the at least one moisture absorbing layer are situated between the top plate and the bottom plate.

In certain embodiments, the clear acrylic resin is applied as a liquid or a powder. In further embodiments, the methods further comprise, prior to step b), the step of sanding the fiber cement board material. In other embodiments, the transfer medium comprises clay (e.g., paper comprising clay particles, such as BEAVER paper TexPrint XP-HR or similar paper). In certain embodiments, the paper comprising clay and other materials are the same or similar to those found in Pat. Pub. 20070207926 and U.S. Pat. No. 4,387,132, both of which are herein incorporated by reference as if fully set forth herein. In further embodiments, the contacting is conducted at temperature of at least 170 degrees Fahrenheit (e.g., at least 180 . . . 200 . . . 220 . . . 240 . . . 260 . . . 280 . . . 300 . . . 320 . . . 340 . . . 360 . . . 380 . . . 400 . . . 420 . . . or 440 degrees Fahrenheit). In some embodiments, the methods comprise a step of heating the cement fiber board material (or other material such as wood, aluminum or other metal, or plastic) at a temperature of at least 170 degrees Celsius.

In other embodiments, the present invention provides compositions comprising: a) cement fiber board material (or other material such as wood, aluminum or other metal, or plastic) comprising a surface, b) a clear acrylic resin layer on the surface of the cement fiber board (or other material); and c) a fixed image, wherein the fixed image is formed in the clear acrylic resin layer, and wherein the fixed image has: i) a fixed image optical density value within about 1.5 (e.g., within about 1.4 . . . 1.1 . . . 0.9 . . . 0.7 . . . 0.4 . . . or 0.1) of a corresponding transfer image optical density value; or ii) a fixed image optical density value of at least 0.7 (e.g., ad optical density of 0.8, . . . 1.0 . . . 1.5 . . . 1.9 . . . 2.2 . . . or greater). In further embodiments, the surface of the cement fiber board material is coated with an opaque primer (e.g., a heat stable primer).

In some embodiments, the present invention provides compositions comprising: a) cement fiber board material (or other material such as wood, aluminum or other metal, or plastic) comprising a surface coated with an opaque primer, and b) a clear acrylic resin layer on the surface of the cement fiber board (or other material), wherein the clear acrylic resin layer is configured to receive a fixed image via sublimation (e.g., the clear acrylic resin layer will allow successful sublimation and the surface material is cut the appropriate size to fit into a heat press for sublimation).

In certain embodiments, the present invention provides methods comprising: a) providing a product comprising: i) cement fiber board material (or other material such as wood, aluminum or other metal, plastic, or other material) comprising a surface, and ii) a clear acrylic resin layer on the surface, wherein the clear acrylic resin layer is configured to receive a fixed image via sublimation; and b) transporting the product to a production facility configured to sublimate images into the clear acrylic resin layer via sublimation. In further embodiments, the surface of the cement fiber board material is coated with an opaque primer (e.g., heat stable primer).

In some embodiments, the present invention provides methods comprising: a) providing a product comprising: i) cement fiber board material (or other material such as wood, aluminum or other metal, plastic, or other material) comprising a surface, ii) a clear acrylic resin layer on the surface of the cement fiber board; and iii) a fixed image, wherein the fixed image is formed in the clear acrylic resin layer, and wherein the fixed image has: i) a fixed image optical density value within about 1.5 of a corresponding transfer image optical density value; or ii) a fixed image optical density value of at least 0.7; and b) installing the product on the floor of a room. In certain embodiments, no additional flooring material is applied on top of the surface material, and instead, the surface material with the image surfaces as the finished floor.

In certain embodiments, the present invention provides systems comprising: a) cement fiber board material comprising a surface, b) a clear acrylic resin layer on the surface of the cement fiber board material (or other material such as wood, aluminum or other metal, plastic, or other material), and c) a transfer medium comprising a transfer image. In some embodiments, the system further comprises d) a top plate and a bottom plate, wherein the cement fiber board material and the transfer medium are between the top plate and the bottom plate. In particular embodiments, the systems further comprise at least one moisture absorbing layer. In further embodiments, the moisture absorbing layer is between the top plate and the bottom plate. In other embodiments, the systems further comprise a compressive layer. In particular embodiments, the compressive layer is between the top plate and the bottom plate. In further embodiments, the systems further comprise at least one moisture absorbing layer and a compressive layer. In some embodiments, the at least one moisture absorbing layer and the compressive layer are between the top plate and the bottom plate.

In some embodiments, the present invention provides a method for printing an image onto a surface material, comprising: a) providing a surface material and a transfer medium comprising a transfer image, b) coating the surface material with a liquid acrylic resin to create a coated surface, and c) contacting said coated surface with said transfer medium such that a fixed image is formed in said coating to create a printed surface. In some embodiments, the transfer medium is a digital dye sublimation paper wherein the paper may or may not comprise clay. In some embodiments, the surface material is wood.

In some embodiments, the present invention provides a method for printing an image onto a surface material comprising: a) providing a surface material and a transfer medium comprising a transfer image, b) coating the surface material with a first opaque primer and a second liquid acrylic resin to create a coated surface, and c) contacting said coated surface with said transfer medium such that a fixed image is formed in said coating to create a printed laminate. In some embodiments, the transfer medium is a digital dye sublimation paper wherein said paper may or may not comprise clay. In some embodiments, the surface material is wood.

In some embodiments, the present invention provides compositions comprising: a) a surface material, b) a liquid acrylic resin, and c) a fixed image, wherein the fixed image is formed in the liquid acrylic resin on the surface material, and wherein the fixed image has a fixed image optical density value within about 1.5 of a corresponding transfer image optical density value. In certain embodiments, the fixed image optical density value is within about 1.0 of the corresponding transfer image optical density value. In other embodiments, fixed image optical density value is within about 0.5 of the corresponding transfer image optical density value. In certain embodiments, the fixed image optical density value is within about 0.3 of the corresponding transfer image optical density value. In additional embodiments, the fixed image optical density value is within about 2.0, 1.8, 1.6, 1.4, 1.2, 1.0, 0.8, 0.6, 0.5, 0.4, 0.3, 0.2, or 0.1 of the corresponding fixed image optical density value (e.g., as measured by a densitometer).

In certain embodiments, the present invention provides compositions comprising: a) a surface material, b) a liquid acrylic resin, and c) a fixed image, wherein the fixed image is formed in the liquid acrylic resin on the surface material, and wherein the fixed image has a fixed image optical density value of at least 0.7. In some embodiments, the fixed image optical density value is at least 0.8. In other embodiments, the fixed image optical density value is at least 1.0. In further embodiments, the fixed image optical density value is at least 0.9, 1.0, 1.2, 1.4, 1.6, 1.8, 2.0, or 2.2 (e.g., when measuring a shade of black in the fixed image).

In some embodiments, the fixed image comprises a dye. In certain embodiments, the fixed image comprises sublimated dye (e.g., sublimation dye that has been sublimated into a material such as a liquid acrylic resin). In particular embodiments, the fixed image comprises a heat sensitive dye. In some embodiments, the fixed image comprises a diffusion dye.

In other embodiments, the fixed image has a visual appearance (e.g., it can be seen by the human eye when light is reflected from it). In particular embodiments, at least a portion of the visual appearance is one or more shades of black. In some embodiments, at least a portion of the visual appearance is one or more shades of red. In certain embodiments, at least a portion of the visual appearance is one or more shades of orange. In further embodiments, at least a portion of the visual appearance is one or more shades of yellow. In other embodiments, at least a portion of said visual appearance is one or more shades of green. In some embodiments, at least a portion of the visual appearance is one or more shades of blue. In yet other embodiments, at least a portion of the visual appearance is one or more shades of violet. In additional embodiments, at least a portion of the visual image is a pattern. In some embodiments, at least a portion of the visual image represents an object (e.g., animal, person, vase, tree, etc.).

In some embodiments, the present invention provides methods for forming an image in a surface material, comprising; a) providing; i) a surface material, and ii) a transfer medium comprising a transfer image; b) applying a coating to the surface material that facilitates image transfer from a transfer medium comprising a transfer image; and c) contacting at least a portion of the surface material with at least a portion of the transfer medium such that a fixed image is formed in the surface material. In some embodiments, the surface material is wood. In some embodiments, the transfer medium comprises a dye sublimation paper that may or may not comprise clay. In some embodiments, the coating applied to the surface material is a liquid acrylic resin, a white primer coat, or a combination of a liquid acrylic resin and a white primer coat.

In certain embodiments, the contacting is conducted under heat and/or pressure. In particular embodiments, the pressure is at least 5 pounds per square inch (e.g., 8, 10, 15 or 20 pounds of pressure per square inch). In some embodiments, the pressure is at least 30 pounds per square inch (e.g., at least 30, 35, 40, 45, or 50 pounds of pressure per square inch). In other embodiments, the pressure is about 40 pounds per square inch. In certain embodiments, the pressure has a range of 1-250, 10-100, 20-60, 30-50, or 35-45 pounds of pressure. In some embodiments, the contacting is for a time less than 5 seconds (e.g., 4 seconds, 3 seconds, or 2 seconds). In particular embodiments, the contacting is for a time of less than 10 seconds (e.g., about 9, 8, 7, or 6 seconds). In certain embodiments, the contacting is for a time of less than 20 seconds (e.g., 19, 18, 17, or 16 seconds). In other embodiments, the contacting is for a time of less than one minute. In particular embodiments, the contacting time is in a range from 1 second to 10 minutes, or 6 seconds to 5.0 minutes, or 15 seconds to 3.0 minutes, or 25 seconds to 2.0 minutes, or 35 seconds to 1.5 minutes, or 40 seconds to 1.5 minutes. In certain embodiments, the contacting time is about 2-8 minutes, or about 3-7 minutes, or about 4-6 minutes. In certain embodiments, the contacting time is about 5 minutes (e.g., 4, 4.1, 4.2, 4.3, 4.4, 4.5, 4.6, 4.7, 4.8, 4.9, 5.0, 5.1, 5.2, 5.3, 5.4, or 5.5 minutes).

In some embodiments, the contacting is conducted at a contacting temperature of at least 350 degrees Fahrenheit (e.g., at least 350, . . . 360, . . . 370, . . . 380, . . . 390 . . . 400 . . . 410 . . . 420 degrees Fahrenheit). In other embodiments, the contacting is conducted at a contacting temperature of at least 200 degrees Fahrenheit.

In certain embodiments, the present invention provides methods for heat transfer printing, comprising; a) providing; i) a surface material; ii) a transfer medium comprising a transfer image, iii) an image transfer device configured for heating and pressing the surface material, and iv) a liquid acrylic resin; b) applying said liquid acrylic resin to the surface material that facilitates image transfer from a transfer medium comprising a transfer image; c) heating the surface material with the image transfer device at a temperature of at least 155 degrees Celsius, and d) contacting at least a portion of the surface material with at least a portion of the transfer medium such that a fixed image is formed in the surface material. In some embodiments, the transfer medium comprising a dye sublimation paper that may or may not comprise clay. In some embodiments, a white primer coat in applied to the surface material alone, or in combination with, a liquid acrylic resin.

In certain embodiments, the contacting step is conducted under pressure, wherein the pressure is applied with the image transfer device or system. In some embodiments, the pressure is at least 10 pounds per square inch (e.g., at least 20, 25, 30, 35, 40, 45 pounds per square inch). In certain embodiments, the image transfer device is a heat press (e.g., a dual heat platen vulcanizer, Geo Knight 994 Combo Press, an 898 Airpro automatic air operated press, or similar device). In some embodiments, the image transfer device is a heat press capable of heating the surface material from at least two sides. In particular embodiments, the image transfer system comprises a conveyor belt and/or heatable rollers (e.g., wherein heating occurs during movement of a material through the rollers).

In certain embodiments, the fixed image has a fixed image optical density value. In some embodiments, the fixed image has a fixed image optical density value within about 1.5 of a corresponding transfer image optical density value. In certain embodiments, the fixed image optical density value is within about 1.0 of the corresponding transfer image optical density value. In other embodiments, fixed image optical density value is within about 0.5 of the corresponding transfer image optical density value. In certain embodiments, the fixed image optical density value is within about 0.3 of the corresponding transfer image optical density value. In additional embodiments, the fixed image optical density value is within about 2.0, 1.8, 1.6, 1.4, 1.2, 1.0, 0.8, 0.6, 0.5, 0.4, 0.3, 0.2, or 0.1 of the corresponding fixed image optical density value (e.g., as measured by a densitometer).

In certain embodiments, the fixed image has a fixed image optical density value of at least 0.7. In some embodiments, the fixed image optical density value is at least 0.8. In other embodiments, the fixed image optical density value is at least 1.0. In further embodiments, the fixed image optical density value is at least 0.9, 1.0, 1.2, 1.4, 1.6, 1.8, 2.0, or 2.2 (e.g., when measuring a shade of black in the fixed image).

In some embodiments, the transfer medium comprises a sheet of paper (e.g., standard printed paper). In other embodiments, the transfer medium comprises high quality ink jet paper (e.g., AcuPlot, Avery Brilliant Color Ink Jet Paper, or Epson Photo Quality Ink Jet Paper). In some embodiments, the transfer medium comprises a dye sublimation paper. In some embodiments, the dye sublimation paper comprises clay.

### DESCRIPTION OF THE FIGURES

FIG. 1 shows one embodiment of how to arrange the various components for sublimation into a tile, such as a cement fiber board tile.

FIG. 2 shows one embodiment of how to arrange the various components for sublimation into a tile. In this embodiment, a compressible layer (green rubber mat in this figure) is employed between the bottom platen and the printed transfer image (e.g., in order to help form a tight seal between the transfer image and tile when sublimating).

FIGS. 3A and 3B show a photograph of the resulting images formed in cement fiber board using the conditions described in Example 3.

FIG. 4 shows a photograph of the resulting image formed in cement fiber board using the conditions described in Example 4.

FIG. 5A shows a photograph of the resulting image formed in cement fiber board using the conditions described in Example 5, and FIG. 5B shows a control control panel for comparison to the image in FIG. 5A.

FIG. 6A shows a sublimation print prior to use, and FIG. 6B shows a photograph of the resulting image formed in the fiber cement board using the conditions described in Example 6. The images in FIGS. 6A and 6B are aligned such that the close optical density (OD) match between the original printed image and the image in the fiber cement board can be easily seen.

FIG. 7 shows one embodiment of how various components could be arranged for sublimation. In particular, this figure, from top to bottom, shows a top heat platen 1, a compressive layer 2, a moisture absorbing material layer 3, a transfer image on paper 4, a fiber cement tile with clear acrylic sublimation layer 5, a second moisture absorbing material layer 6, and a bottom plate 7 (e.g., which may or may not be heated).

FIG. 8A shows a sublimation print prior to use, while FIGS. 8B, 8C, and 8D show a photograph of the resulting image formed in the fiber cement board using the conditions described in Example 7

FIG. 9 shows a photograph of the results of the sublimation from Example 8.

### DEFINITIONS

To facilitate an understanding of the invention, a number of terms are defined below.

As used herein, the terms “fixed image” and “fixed image formed” in a material, refer to dye or ink that has been transferred into a surface (e.g., heat transferred into a surface material, such as a clear acrylic resin layer) and that changes the visual appearance of the surface material (e.g., makes it darker, or lighter, changes the color, adds a pattern or representation of an image).

As used herein, the term “optical density” refers to reflected light intensity measurement that can be made, for example, by a densitometer.

As used herein, the term “corresponding transfer image” refers to the dye in the transfer medium that could be used (e.g., in heat transfer printing) to form a fixed image in a surface material. Generally, the corresponding transfer image when compared to a fixed image, is not the actual transfer image used to transfer the image into the surface material (since the transfer image is “spent”), but instead is made by the same method as the actual transfer image used to form the fixed image (e.g., the same digital picture is printed out onto the same type of paper using the same printer, etc).

As used herein, the term “fixed image optical density value” is an optical density value obtained from a fixed image, or a digital picture of a fixed image. This value may be obtained, for example, by using a densitometer or a gray scale.

As used herein, the term “transfer image optical density value” is an optical density value obtained from a transfer image, or a digital picture of a transfer image. This value may be obtained, for example, by using a densitometer or a gray scale.

As used herein, the term “transfer medium” refers to any material that is capable of having a transfer image formed in it (e.g., by an ink jet printer), and that can then transfer this image to a surface material under heat and/or pressure. Examples of transfer media include, but are not limited to, ordinary printer paper, high quality ink-jet paper, and fabric.

As used herein, the term “contacting-temperature” refers to the temperature at which the transfer image is applied to a surface material.

As used herein, the term “coating” refers to any material that is capable of being applied to a surface material, and that facilitates the practice of the present invention.

As used herein, the term “surface material” is any material that is capable of receiving a fixed image by means of the systems and methods of the present invention.

### GENERAL DESCRIPTION OF THE INVENTION

The present invention provides systems and methods for imprinting images with novel optical properties into materials used in covering floors and walls, as well as other materials. Systems and methods for imprinting images with novel optical properties is found in U.S. Provisional Application Ser. No. 60/953,880 filed Aug. 3, 2007, incorporated herein by reference in its entirety. The systems and methods as described herein allow for high quality images to be imprinted onto flooring and wall materials, for example flooring backer board. Backer board is a term used to describe a drywall-like product that serves as a foundation under ceramic tile. Backer board is also sometimes called cement fiber board, and can be used for other applications, such as for house siding. Cement backer board was developed to replace the cement mud and metal lath systems installed by craftsmen. Tile backer board now comes in all different types from cement to specialized gypsum-core products that are faced with fiberglass.

In some embodiments, the present invention provides systems and methods for imprinting images with novel optical properties into flooring and wall materials, such as backer board. Examples of backer board are marketed by James Hardie International (www followed by “jameshardie.com”). HardieBacker™ board, as supplied by James Hardie International, provides an exemplary backer board comprising cement composite, as compared to traditional glass mesh boards. A cement composite backer board is superior to a glass mesh board in that it has superior workability (e.g., more compressive, more flexible strength, durability, etc.) and does not contain abrasive glass mesh or messy aggregate while providing the highest levels of moisture and mold protection available. Backer board is typically provided in various thicknesses, such as ¼ inch, ½ inch and the like. The present invention is not limited to the thickness of the backer board, nor the source, used for imprinting, and any thickness and source is considered amenable with systems and methods of the present invention.

In some embodiments, the present invention comprises methods and systems for imprinting images in backer board. In preferred embodiments, the present invention provides systems and methods for imprinting images into backer board comprising cement composite. In some embodiments, the thickness of the cement composite backer board is ¼ inch, whereas in other embodiments the thickness of the backer board is ½ inch. In some embodiments, the backer board used for imprinting images with novel optical properties is used as flooring material. In some embodiments the backer board is used as wall material.

In some embodiments, the substrate used for image transfer, such as backer board, is first primed with a white primer coat. In some embodiments, the white primer coat is then covered by a liquid acrylic resin for sublimation of the image upon transfer. In some embodiments, a transfer material comprising the image to be transferred to the substrate is placed on the liquid acrylic resin. In some embodiments, the image is sublimated into the liquid acrylic resin under pressure and high heat thereby creating a surface with an image, wherein said image comprises novel optical properties. Examples of using methods and systems of the present invention to imprint images into backer board used as flooring or walls includes, but is not limited to, its use as a bathroom flooring wherein images of tile, grout, designs, etc. are imprinted into the backboard such that it is no longer necessary to lay actual tile, etc. on the floor. Examples of backer board imprinted with images that find utility as wall coverings include, for example, backer board imprinted with a wall paper design and the like such that the backer board is installed on a wall and painting or applying wall paper covering is no longer needed (e.g., taking the place of drywall).

In some embodiments, the present invention comprises a substrate such as flooring or wall material, for example backer board, that is primed with a white primer. In some embodiments, prior to image transfer and the application of a liquid acrylic sublimation clear coat, the substrate is coated with a primer coat, for example a white paint primer. For example, a backer board is first coated with a white paint primer such as 1-2-3-ZINSSER Bulls eye primer, ZINSSER B-I-N® Shellac-Base Primer-Sealer, ZINSSER B-I-N® Primer, or any other white primer. In preferred embodiments, a ZINSSER B-I-N® Shellac-Base Primer-Sealer is used to coat the substrate, for example backer board. The white primer coat can be applied in any fashion, for example, spraying on, brushing on, or dipping the substrate into the primer. In preferred embodiments, the white primer is pre-applied to the substrate, for example a white primer coat is baked onto the substrate prior to application of a liquid acrylic resin.

In some embodiments, a liquid acrylic clear coat is applied to the flooring or wall material for sublimation of the transferable image. Examples of liquid acrylic sublimation finishes include, but are not limited to, a polyacrylic finish such as Ace brand Poly-Finish semi-gloss, gloss, clear, and flat, MINWAX Glass and semi-gloss, a satin polyacrylic protective finish, and Sherwin Williams SHER-CLEAR acrylic clear coat. In some embodiments, Sherwin Williams SHER-CLEAR is utilized as a liquid acrylic clear coat. In preferred embodiments, Sherwin Williams SHER-CLEAR is mixed with denatured alcohol prior to application, for example to thin the SHER-CLEAR thereby allowing for additional ease of application. In some embodiments, a coat of SHER-CLEAR is also applied after image transfer is complete.

In some embodiments, the image is first imprinted on a sublimation paper, and the image subsequently sublimated into the liquid acrylic clear coat. Transfer image, or dye sublimation print paper is commercially available, for example, through Beaver Paper Company. Beaver paper provides dye sublimation paper or a variety of uses, for example TEXPRINT95_{PLUS} (a digital dye sublimation print paper with a “Quick-Dry” transfer coating), TEXPRINT-RWS, TEXPRINT-OFS (optimized for oleo-resinous dye sublimation inks), TEXPRINT-3D (a conformable sublimation film), TEXPRINT-XP and XP Plus and XP-HR (large format papers), TEXPRINT-LFO (oil based large format paper), TEXPRINT-GFO (oil based grand format paper), PROTEX (a thermal transfer tissue), and TEXPRINTABLES (sublimation fabrics). In some embodiments, the preferred dye sublimation paper for image transfer is TEXPRINT-XP-HR. TEXPRINT-XP-HR, for example, leaves minimal residue when the paper is removed after practicing the sublimation methods of the present invention. In preferred embodiments, the dye sublimation print paper of the present invention comprises a top coat of hydrous aluminum cilicates such as clay. Examples of dye sublimation print paper compositions useful in methods of the present application include, but are not limited to, those described in JP 03177928B2, Pat. Pub. 20070207926, and U.S. Pat. No. 4,387,132 which are herein incorporated by reference as if fully set forth herein.

In some embodiments, pressure for sublimation of an image into the resin coating on a flooring or wall material (or other material) is applied by a heated platen system, for example a vulcanizer. The heating of the substrate and sublimation of the image is performed, for example, using a dual heat platen vulcanizer, wherein heat is applied from both the top and the bottom. The heat may also be applied only from the top or bottom platen. An example of a dual heat platen vulcanizer is sold by PEPETOOLS, Inc., Geo Knight Maxi-Press (S/N 459) and Geo Knight 994 Combo Swing Press. In some embodiments, pressure applied to a single or dual heat platen system is at least 40 psi, at least 45 psi, at least 50 psi, at least 60 psi, at least 70 psi, at least 80 psi, at least 90 psi, at least 100 psi, at least 110 psi, at least 120 psi. In preferred embodiments, pressure applied to a deal heat platen system is about 45 psi to about 100 psi.

In some embodiments, the present invention provides methods for imprinting images into flooring and wall materials, such as backer board. HardieBoard™, for example, is coated with a white primer such as ZINSSER B-I-N® Shellac-Base Primer-Sealer. In some embodiments, the backer board is pre-primed with, for example, baked on primer. Sherwin Williams SHER-CLEAR is thinned with denatured alcohol and applied to the primed board. In some embodiments, the SHER-CLEAR is applied only once, whereas in other embodiments the acrylic coat is applied in multiple coats (e.g., at least 2, at least 3, at least 4, etc. coats of acrylic). The sublimation paper containing the image is applied to the acrylic coat and heat and pressure are applied to transfer the image to the acrylic resin. For example, 60 to 100 lbs of pressure is applied by a dual-heat platen system for about 5 minutes at 370-400° F. In some embodiments, a green heat conductive pad (e.g., ⅛ inch thickness) is placed between the sublimation paper and the heat platen. The transferred image is allowed to cool, at which time the sublimation paper is removed and the image can be further coated, buffed, etc. to increase luster or to provide added protection to the newly transferred image.

In some embodiments, the flooring or wall material, such as backer board, is heated in a dual platen heat press prior to applying a primer coat. Such pre-heating of the material allows for the removal of moisture, etc. The white primer coat is then applied as described above, followed by the application of a clear acrylic resin as described above. Sublimation paper is then applied to the material for image transfer, followed by the placement of a green conductive heating pad (e.g., ⅛ inch thickness) between the sublimation paper and the heat platen. Heat (approximately 5-6 minutes), heavy pressure, and high temperature (e.g., 340-400° F., 360-400° F., or at least 300° F.) are applied and the transferred image is allowed to cool. Once cool, the paper is removed and an optional coat of clear acrylic is applied.

### DETAILED DESCRIPTION OF THE INVENTION

The following discussion provides a description of certain preferred illustrative embodiments of the present invention and is not intended to limit the scope of the present invention. For convenience, the discussion focuses on the application of the present invention to the process of heat transfer printing of fixed images using sublimable dyes, into a surface material to which a coating that facilitates image transfer from a transfer medium comprising a transfer image has been applied . Preferred coating materials include liquid acrylic resin and white primer. The image transfer paper is preferably a dye sublimation paper that may or may not comprise clay. It should be understood that the methods and systems are applicable and intended for use with a wide variety of similar materials. The description is provided in the following sections: I) Forming Fixed Images in Surface Materials; II) Surface Materials; III) Transfer Mediums and Devices; IV) Dyes; V) Printing Devices; and VI) Fixed Image Characteristics.

### I. Forming Fixed Images in Surface Materials

As discussed above, the presently claimed invention comprises systems and methods for transferring (e.g., heat transfer printing) images into surface materials. The present invention allows, in some embodiments, for very short image transfer times that allow rapid production (e.g., high throughput production) of products with high optical density images formed in them. The present invention thus provides a solution to the previously unmet need for bright, true, high optical density color image printing in surface materials.

In some embodiments, a coating is applied to a surface material prior to the image transfer. In some embodiments, the coating comprises a polymer resin such as polyacrylic resin. In some embodiments, the coating comprises any transparent, substantially transparent, or partially transparent material that can be coated on a surface and that can receive sublimation dyes.

In some embodiments, a liquid acrylic clear coat is applied to the surface material prior to the image transfer. Examples of liquid acrylic sublimation finishes include, but are not limited to, a polyacrylic finish such as Ace brand Poly-Finish semi-gloss, gloss, clear, and flat, MINWAX™ Glass and semi-gloss, a satin polyacrylic protective finish, and Sherwin Williams SHER-CLEAR™ acrylic clear coat. In some embodiments, the application of a liquid acrylic clear coat to the surface material for image transfer imparts anti-graffiti properties to the surface material. For example, the use of a liquid acrylic clear coat allows for easier removal of, for example, paint products when compared to surfaces without a liquid acrylic clear coat application. It was found while performing experiments in developing embodiments of the present invention that coating a raw wood substrate with a liquid acrylic clear coat for sublimation, besides providing for superior image transfer, also imparts a natural wood glow to the image. In some embodiments, prior to image transfer and the application of a liquid acrylic clear coat, the substrate is first coated with an opaque primer coat such as a white paint primer coat. In some embodiments, a substrate is first coated with a white paint primer such as 1-2-3-ZINSSER™ Bulls eye primer, or any other white primer, prior to a liquid acrylic coat and image sublimation. An attribute of utilizing a white primer coat, as compared to a clear coat primer alone, is that, for example, the white background highlights the image to a greater degree than a clear acrylic resin layer without a white primer coat. In some embodiments, the liquid acrylic clear coat and/or the white primer coat is applied by, for example, spraying on, brushing on, or dipping the substrate into the primer(s). In some embodiments, the primer coat(s) are allowed to dry prior to image transfer.

Heat transfer printing according to the present invention is performed, in some embodiments, by using a heat press. Methods for heat transfer printing using sublimation or other heat activated inks or dyes may be conducted using methods described in U.S. Pat. Nos. 5,246,518, 5,248,363 and 5,302,223 to Hale (incorporated herein by reference in their entireties).

In some embodiments, temperature for sublimation of image onto a substrate is at least 350° F., at least 360° F., at least 370° F., at least 380° F., at least 400° F., at least 420° F. In preferred embodiments, temperature for sublimation is about 380° F. to about 400° F. In some embodiments, the top heat platen temperature for transfer is less than that of the bottom platen. For example, in some embodiments the top heat platen temperature is approximately 200-225° F. whereas the bottom platen temperature is approximately 390-425° F. In some embodiments, the application time for heating and applying pressure for sublimation of an image onto a substrate is at least 30 seconds, at least 35 seconds, at least 40 seconds, at least 45 seconds, at least 50 seconds, at least 60 seconds, at least 70 seconds, at least 80 seconds, at least 90 seconds, at least 2 minutes, at least 3 minutes, at least 5 minutes, at least 6 minutes, at least 7 minutes, at least 8 minutes. In some embodiments, a green conductive heating pad is positioned between the heat platen and the sublimation paper during image transfer.

### II. Surface Materials

A. Types of Surface Materials

The present invention may be used with any type of surface material that is capable of accepting a coating that facilitates image transfer from a transfer medium comprising a transfer image. In some embodiments of the present invention, the surface material comprises natural fibers (e.g., cotton, wool, silk, etc.). In other embodiments, the surface material comprises synthetic fibers (e.g., nylon, polyester, etc.). In yet other embodiments, the surface material comprises synthetic polymer materials (e.g., plastics). In additional embodiments, the surface material comprises metal. In some embodiments, the surface is a laminate material that, once coated and printed into by the methods of the present invention, can be affixed to another material (e.g., wall, furniture, etc.) to enhance the image of the other material. In certain embodiments, the surface is cement fiber board. In some embodiments, the surface material is coated and printed into after it is affixed to the other material. Indeed, any substrate capable of withstanding temperatures for image transfer as described herein are useful as substrates of the present invention.

In certain embodiments of the present invention, the surface material comprises wood. The types of wood surfaces with which the present invention may be used include, but are not limited to, veneers, plywood, particleboards, and other products having at least one natural wood surface. The natural wood surfaces of the present invention may be either hardwood species or softwood species. Suitable hardwood species include, but are not limited to, Afromosia, Anegre, Ash, Beech, Birch, Bubinga, Cherry, Chestnut, Cypress, Eucalyptus, Hickory, Koto, Mahogany, Maple, Oak, Pear, Pecan, Poplar, Rose, Sapeli, Teak, Tupelo, and Walnut. Suitable softwood species include, but are not limited to, Pine, Hemlock, Douglas Fir, and Yew.

For reference, the following wood product definitions are provided.

Veneer: A thin sheet of wood ranging in thickness from ⅛″ to 1/100″ (0.3 to 0.02 cm). Depending on the market, the standard thickness is 1/40″ (0.06 cm), although it may vary from species to species.

Plywood: Any combination of veneers, lumber, core, paper or other material joined together with adhesive to make a one piece construction. Plywood can be of any thickness. Standards are ⅛″, ¼″, ½″, ¾″, or 1″ (0.3, 0.6, 1.3, 1.9, or 2.5 cm). Hardwood plywood usually has a face, core and back.

Face: Any sheet of veneer made from various components that is exposed to view. Examples are wall paneling, desk tops, or counter fronts.

Inner Plies: Any piece or sheet of plywood other than the face and back.

Core: The inner ply of any plywood that has a face and back. The core can be made of lumber, particle board, medium density fiber board (MFD) veneer core, paper core, or resin.

Back: Sometimes called backing grade when referring to veneer. The material used on the reverse side of plywood from the face.

Particle Board: A panel of small fibers that are bonded together with adhesive, heat, and pressure.

Component: Individual sheets of veneer, both in width and length, used to make a face.

Layon: “Jointed veneer” pieces forming a made-to-measure panel ready for application to a door or panel. It is produced by trimming the veneer to give it a straight edge so that it can be stitched together so as to create the width necessary to cover the surface, which is to be veneered. A non-limiting variety of matches from a flitch can be employed to create a pattern on the veneer:

Flitch: Any part of a log that is produced for the purpose of cutting veneer.

Random Match: Sheets of veneer joined together with no definite pattern or color.

Center Matched: An even number of veneer pieces from the same flitch, with a definite line in the center, to show a definite pattern.

Butt Matched: Two pieces of veneer joined at the ends to produce a definite pattern.

Balance Match: Two or more pieces of veneer of equal length and width joined together to make a face.

Book Match: Equal pieces of veneer from the same flitch (½ log) joined together to produce a balanced and definite pattern.

Running Match: A face or panel made from components joined together without flipping through the entire flitch.

Slip Match: Pieces of veneer are slipped from the bundle or flitch without flipping.

Blockmottle: A variegated pattern that looks like small blocks as opposed to crossfire or figure.

Cathedral: Grain pattern in the form of a “V” or inverted “V” running the length of the sheet.

Burl: A distortion or unusual growth within a log that results in a blister like grain. Very unusual and expensive. Used primarily for auto dashboards and fine furniture.

Cross Fire (also Figure or Flame): The appearance of shadows or waves that run across the grain of any species. Other terms such as fiddle back and curly also apply.

Flat sliced: Veneer is sliced parallel to the center of the flitch. This results in Cathedral Grain.

Rotary (Peeled): Veneer is peeled from whole log.

Quartered: Veneer is sliced perpendicular to the growth ring. This results in Wild Grain.

Drift Cut: Similar to quarter cut. Normally only cut from large oak logs to achieve a straight grain veneer.

Half Round: Cut on a half round machine to produce a flat cut effect, and to avoid defective or dark heart woods.

Lengthwise Sliced: Cut on a Japanese machine from flat sawn lumber. Used for thicker veneers.

In certain embodiments, the surface material comprises cement fiber board. In certain embodiments, the cement fiber board material comprises about 10% cellulose fiber and about 90% cement (e.g., Portland cement). In other embodiments, the cement fiber board comprises Portland cement, flay ash, and wood fiber. In particular embodiments, the surface material comprises HardieBacker™, HardiePanel™, CertainTeed™ Fiber Cement Siding, or similar products that are available commercially.

B. Uses of Surface Materials

The present invention contemplates surface materials, with a fixed image, with any shape or texture. Examples of uses of surface materials with a fixed image therein include, but are not limited to, furniture, flooring, wall coverings, decorative trim and moldings, printing paper, stationary, envelopes, crafts, window blinds, vertical louvers, pleated window shades, business cards, point-of-purchase displays, book covers, menu covers, interior and exterior vehicle trim, picture frame mats, tags, greeting cards, baseball cards, scrapbooks, photo albums, dishes, trays, food containers, three-dimensional articles, pedestals, natural wood light diffusers, light panels, lampshades, candle luminaries, partitions, screens, place mats, floor mats, decorative appliquáes, acid-free and/or photo-safe archival applications, inlays, and translucent inserts.

### III. Transfer Media

In the present invention, a transfer image (e.g., comprising dye) is formed in any type of transfer media (e.g., a sheet of paper). Examples of materials that may be used as a transfer medium, include, but are not limited to, (1) materials that can be printed upon by a printer, (2) materials that will facilitate and withstand heat transfer temperatures, and (3) materials that will facilitate incorporation of dye into the surface material. In preferred embodiments, the transfer medium is standard bond paper. In other preferred embodiments, the transfer medium is high quality ink jet paper. However, the medium may be any paper, for example, any paper used with mechanical thermal printers, ink jet printers, and laser printers. Other materials, such as sheets of metal, plastic, or fabric may also be used. The use of transfer media is disclosed, for example, in U.S. Pat. No. 4,406,662 to Beran et al., Nos. 5,246,518, 5,248,363, 5,302,223 and 5,487,614 to Hale, Nos. 5,431,501, 5,522,317, 5,555,813, 5,575,877, 5,590,600, 5,601,023, 5,640,180, 5,642,141, 5,734,396, and 5,830,263 to Hale et al., No. 5,746,816 to Xu, and Nos. 5,488,907 and 5,644,988 to Xu et al, herein incorporated by reference in their entireties.

In some embodiments, the image is first imprinted on a transfer paper, and the image subsequently sublimated into the liquid acrylic clear coat on the surface material. Transfer image paper, or dye sublimation print paper is commercially available, for example, through Beaver Paper Company (Atlanta, Ga.). Beaver paper provides dye sublimation paper for a variety of uses useful in practicing the methods of the present invention, for example digital dye sublimation paper such as TEXPRINT95_{PLUS} (a digital dye sublimation print paper with a “Quick-Dry” transfer coating), TEXPRINT-RWS, TEXPRINT-OFS (optimized for oleo-resinous dye sublimation inks), TEXPRINT-3D (a conformable sublimation film), TEXPRINT-XP and XP Plus and XP-HR (large format papers), TEXPRINT-LFO (oil based large format paper), TEXPRINT-GFO (oil based grand format paper), PROTEX (a thermal transfer tissue), and TEXPRINTABLES (sublimation fabrics). In some embodiments, the dye sublimation paper for image transfer is TEXPRINT-XP-HR. In some embodiments, the image to be transferred is printed onto the image transfer paper, and the image transfer paper is placed on the pre-coated surface material, heat/pressure are applied, and the system is allowed to cool. In some embodiments, the image transfer paper is subsequently removed from the surface material leaving little to no residue on the substrate material. In preferred embodiments, the dye sublimation print paper of the present invention comprises a topcoat comprised of clay. In some embodiments, the clay is natural in origin such as those comprising hydrous aluminum cilicates. Natural clays (e.g., smectites, hectorites, bentonites) comprise alkali metals or alkaline-earth metals as constituents. In some embodiments, the clay in the sublimation print paper is synthetic clay comprising synthetic silicates. Examples of synthetic silicates include, but are not limited to, sodium lithium magnesium silicates, sodium lithium magnesium fluoride silicates. In some embodiments, the synthetic clay is used in the form of synthetic smectite-type clay. Smectite clays, for example, are a group of swelling clays that take up water and organic liquids between the composite layers and that have marked cation exchange capacities. Examples of dye sublimation print paper compositions comprising clays useful in methods of the present application include, but are not limited to, those described in JP 03177928B2, Pat. Pub. 20070207926, and U.S. Pat. No. 4,387,132 which are herein incorporated by reference as if fully set forth herein, and TEXPRINT-XP HR.

It was found in developing embodiments of the present invention that some of the dye sublimation papers tested left a white residue on the image and substrate when the paper was removed. Although inconvenient, the white residue was removable by applying a soft abrasive to the substrate and rubbing. Soft abrasives useful for removing such residue include, but are not limited to, calcium carbonate based solvent abrasives as those found in, for example, WHINK Glass and Ceramic Cook Top Cleaner. In some embodiments, methods of the present invention comprise the cleaning of the surface material after image transfer has occurred.

In the present invention, a transfer image comprising a dye may be applied to a transfer medium for subsequent heat transfer into a surface material. The dye may be applied to the transfer medium by any suitable means, including, but not limited to, computer-controlled devices such as mechanical thermal printers, ink jet printers, and laser printers. Thus, any digital image may be used including images of solid colors, patterned designs (e.g., woodgrain or marbled designs), and complex figures. The dye is printed at a temperature sufficient to apply the ink, but generally below the activation temperature of the dye. Generally, activation, or sublimation, of the dye does not take place at the time of printing the image on the medium, but occurs during the transfer from the medium to the surface material.

In some preferred embodiments, the dye is applied to the transfer medium by means of a computer-controlled liquid ink printing device, such as an ink jet printer. In some embodiments, a bubble jet printer is used. In other embodiments, a free flow ink jet printer is used. In yet other embodiments, a piezio electric ink jet printer is used. In some embodiments, the dye is applied to the transfer medium by means of a computer-controlled solid ink printing device, such as a phase change ink jet printer. In some embodiments, a ribbon printer is used. In some embodiments, the dye is applied to the transfer medium by means of a computer-controlled electrographic printing device, such as a laser printer or photocopier. The use of such a devices for applying a dye composition to a transfer medium is disclosed in U.S. Pat. No. 5,487,614 to Hale, Nos. 5,431,501, 5,522,317, 5,575,877, 5,601,023, 5,640,180, 5,642,141, 5,734,396, and 5,830,263 to Hale et al., No. 5,746,816 to Xu, and Nos. 5,488,907 and 5,644,988 to Xu et al.

Additional printing apparatuses contemplated under the present invention include, but are not limited to, products marketed by companies such as Brother (Bridgewater, N.J.), Canon (Lake Success, N.Y.), Encad (San Diego, Calif.), Epson (Long Beach, Calif.), Hewlett-Packard (Palo Alto, Calif.), Eastman Kodak (Rochester, N.Y.), Lexmark (Lexington, Ky.), Minolta (Ramsey, N.J.), Oki Data (Mt. Laurel, N.J.), Ricoh (West Caldwell, N.J.), and Xerox (Stamford, Conn.). Other preferred printers include, but are not limited to, EPSON STYLUS PRO, EPSON STYLUS PRO XL, EPSON STYLUS COLOR 3000, EPSON 800, EPSON 850, and EPSON 1520.

### IV. Dyes

In some preferred embodiments, the composition used to create the transfer image is a dye that is produced from sublimation, dye diffusion, or heat sensitive dyes. Dye solids of small particle size, preferably 0.5 microns or less in diameter, are dispersed in a liquid carrier, and one or more agents are used to maintain what may be called, according to various definitions, a colloidal, dispersion or emulsion system. A particularly preferred composition is a liquid dye consisting of 0.05 to 20 percent by weight of one or more sublimation, dye diffusion, or heat sensitive dyes; 0.05 to 30 percent by weight of a dispersant and/or emulsifying agent; 0 to 45 percent by weight of one or more solvents or co-solvents; 0 to 15 percent by weight of one or more additives; and 40 to 98 percent by weight of water. Such compositions are disclosed in U.S. Pat. Nos. 5,640,180, 5,642,141, and 5,830,263 to Hale et al. (incorporated herein by reference in their entireties).

One preferred composition is a dye containing 5 to 30 percent by weight of one or more heat activated dyes; 1 to 20 percent by weight of an emulsifying enforcing agent; 0 to 30 percent by weight of a binder; 0 to 40 percent by weight of one or more humectants; 0 to 10 percent by weight of a foam control agent; 0 to 2 percent by weight of a fungicide; 0 to 10 percent by weight of a viscosity control agent; 0 to 10 percent by weight of a surface tension control agent; 0 to 10 percent by weight of a diffusion control agent; 0 to 15 percent by weight of a flow control agent; 0 to 20 percent by weight of an evaporation control agent; 0 to 10 percent by weight of a corrosion control agent; 0 to 30 percent by weight of a co-solvent; and 30 to 90 percent of a solvent, which may be water. Such compositions are disclosed in U.S. Pat. No. 5,488,907 to Xu et al. and Nos. 5,601,023 and 5,734,396 to Hale et al. (incorporated herein by reference in their entireties).

In some embodiments, the composition (e.g., ink) used to create the transfer image comprise a solid dye that comprises heat activated dyes, and a phase change material, or transfer vehicle, that will liquefy upon the application of heat to the ink composition. A polymer binder and additives may be added to the dye composition. A particularly preferred composition is a solid ink containing 5 to 30 percent by weight of one or more heat activated dyes; 20 to 70 percent by weight of a transfer vehicle such as wax or a wax-like material; 1 to 20 percent by weight of an emulsifying enforcing agent; 0 to 30 percent by weight of a binder; 0 to 15 percent by weight of a plasticizer; 0 to 10 percent by weight of a foam control agent; 0 to 10 percent by weight of a viscosity control agent; 0 to 10 percent by weight of a surface tension control agent; 0 to 10 percent by weight of a diffusion control agent; 0 to 15 percent by weight of a flow control agent; 0 to 10 percent by weight of a corrosion control agent; and 0 to 5 percent of an antioxidant. Such compositions are disclosed in U.S. Pat. No. 5,488,907 to Xu et al. and Nos. 5,601,023 and 5,734,396 to Hale et al. (incorporated herein by reference in their entireties).

In some embodiments, the compositions used to create the transfer image are solid dyes that comprise heat-activated dyes and a phase change material, or transfer vehicle, that will liquefy upon the application of heat to the dye composition. A polymer binder and additives may be added to the dye composition. A particularly preferred composition is a solid dye containing 5 to 30 percent by weight of one or more heat activated dyes; 30 to 70 percent by weight of a transfer vehicle such as wax or a wax-like material; 0 to 30 percent by weight of a binder; and 0 to 30 percent of one or more additives. Such compositions are disclosed in U.S. Pat. Nos. 5,302,223 and 5,487,614 to Hale, Nos. 5,431,501, 5,522,317, and 5,575,877 to Hale et al., and No. 5,644,988 to Xu et al. (incorporated herein by reference in their entireties).

In some embodiments, the compositions used to create the transfer image are liquid dyes that are produced from sublimation, dye diffusion, or heat sensitive dyes. The composition may comprise monomer or polymer materials in either solvent or emulsion form, an initiator or catalyst (which may be compounded into the inks so as to provide separation from the polymer), a surface tension control agent, a dispersing agent, a humectant, a corrosion inhibitor, a flow control aid, a viscosity stabilization aid, an evaporation control agent, a fungicide, an anti-foaming chemical, a fusing control agent, and antioxidants. A particularly preferred composition is a liquid ink comprising of, in addition to inks or dyes, 10 to 20 percent by weight of a surface preparation material; 40 to 90 percent by weight of a solvent, 0 to 40 percent by weight of a co-solvent; and 0 to 30 percent by weight of one or more additives. Such compositions are disclosed in U.S. Pat. No. 5,487,614 to Hale, Nos. 5,431,501, 5,522,317, and 5,575,877 to Hale et al., and No. 5,644,988 to Xu et al. (incorporated herein by reference in their entireties).

In some embodiments, the dye composition used to create the transfer image is a liquid dye that is produced from sublimation, dye diffusion, or heat sensitive dyes. Dye solids of small particle size, no larger than 0.5 microns in diameter, preferably 0.1 microns or less in diameter, are dispersed in a liquid carrier, and one or more agents are used to maintain what may be called, according to various definitions, a colloidal, dispersion or emulsion system. A particularly preferred composition is a liquid ink containing 0.05 to 5 percent by weight of one or more sublimation, dye diffusion, or heat sensitive dyes; 0.05 to 40 percent by weight of a dispersant and/or emulsifying agent; 0 to 45 percent by weight of one or more solvents or co-solvents; 0 to 20 percent by weight of one or more additives; and 40 to 98 percent by weight of water. Such a composition is disclosed in U.S. Pat. No. 5,746,816 to Xu (incorporated herein by reference in its entirety).

In some embodiments, the dye composition used to create the transfer image is a dry toner composition that comprises heat activated dyes encased in a molecular sieve product, one or more binder polymers, and/or one or more charge control additives. A particularly preferred composition is a solid ink containing 3 to 20 percent by weight of a molecular sieve product containing one or more heat activated dyes; 50 to 90 percent by weight of one or more binder materials; and 0.5 to 10 percent of one or more charging additives. Such a composition is disclosed in U.S. Pat. Nos. 5,555,813 and 5,590,600 to Hale et al. (incorporated herein by reference in their entireties).

In some embodiments, methods of the present invention comprise sublimation ink systems. Examples of ink delivery systems include those commercially available from, for example, Sawgrass Technologies, Inc. (Mt. Pleasant, S.C.) such as SUBLIJET IQ and SUBLIM wherein high quality inks, ink delivery system software, and printer compatibility are offered. Image printing systems amenable with such systems include EPSON printers C-88, 1280/1290, R1800, 4000, 4400 and 4800. In preferred embodiments, the EPSON 4000 is utilized for printing the image for sublimation on the dye sublimation paper.

Additional dye and ink compositions and materials contemplated under the present invention include, but are not limited to, products marketed under the names ARTAINIUM UV+ (Tropical Graphics, Oakland Park, Fla.), SUBLIRIBBON, and SUBLITONER (Sawgrass Technologies, Inc.), CELANOL, KEYCO DISPERSE, KEYMICRO, KEYSCREEN, KEYSPERSE, KEYSTONE, KEYTRANS, and SUBLAPRINT (Keystone

Aniline Corporation, Chicago, Ill.), BAFIXAN and CELLITON (BASF A.G., Ludwigshafen, Germany), EASTMAN (Eastman Chemical Company, Kingsport, Tenn.), INTRATHERM (Crompton & Knowles Corporation, Stamford, Conn.), DIACELLITON, DIANIX, and DIARESIN (Mitsubishi Chemical Industries, Ltd., Tokyo, Japan), DYSTAR (DyStar Textilfarben GmbH & Co., Frankfurt, Germany), SUMIPLAST and SUMIKALON (Sumitomo Chemical Co., Ltd., Osaka, Japan), DISPERSOL, VYNAMON, and WAXOLINE (Imperial Chemical Industries Ltd., London, England), CATULIA (Francolor Company, Riefux, France) AUTOTOP, CIBACET, TERAPRINT, and TERASIL (Ciba-Geigy Corporation, Ardsley, N.Y.), OPLAS (Orient Chemical Industries, Ltd., Osaka, Japan), HOSTASOL and SAMARON (Hoechst AG, Frankfurt, Germany), ASTRAZON, CERES, MACROLEX, and RESOLIN (Bayer AG, Leverkusen, Germany), AIZEN (Hodogaya Chemical Co., Ltd., Japan), ORCOCILACRON and ORCOSPERSE (Organic Dyestuffs Corporation, Providence, R.I.), KAYACRYL, KAYALON, KAYANOL, AND KAYASET (Nippon Kayaku Co., Ltd., Tokyo, Japan), and MIKAZOL and MIKETON (Mitsui & Co., New York, N.Y.).

### V. Printing Systems and Devices

The transfer images of the present invention are generally applied with heat and pressure. Any system or device that is capable of applying heat and/or pressure to a transfer medium containing a transfer image such that a fixed image is formed in a surface material is useful for practicing the present invention. In some embodiments, a heat transfer press is employed. The use of a heat transfer machine/device to transfer dyes from the transfer medium to the substrate is disclosed in U.S. Pat. No. 4,406,662 to Beran et al., Nos. 5,246,518, 5,248,363, 5,302,223 and 5,487,614 to Hale, Nos. 5,431,501, 5,522,317, 5,555,813, 5,575,877, 5,590,600, 5,601,023, 5,640,180, 5,642,141, 5,734,396, and 5,830,263 to Hale et al., No. 5,746,816 to Xu, and Nos. 5,488,907 and 5,644,988 to Xu et al. (herein incorporated by reference in their entireties).

Additional heat transfer apparatuses that may be employed with methods and systems of the present invention include, but are not limited to, products marketed by companies such as Geo Knight & Co. (Brockton, Mass.), Hix Corporation (Pittsburg, Kans.), and National Equipment (Pittsburg, Kans.).

In some embodiments, a system or device that is capable of heating the surface material from at least two sides is employed. Such systems allow even heating of surface materials to be printed into. In some embodiments, pressure for sublimation of an image into a substrate is applied by a heated platen system, for example a vulcanizer. The heating of the substrate and sublimation of the image is preferably performed using a dual heat platen vulcanizer, wherein heat is applied from both the top and the bottom. An example of a dual heat platen vulcanizer is sold by PEPETOOLS, Inc (Oklahoma City, Okla.). It was observed in developing embodiments of the present invention that a single platen heat vulcanizer (e.g., top heat only) cause certain substrates to, for example, deform (e.g., warp or otherwise become misshapen) when it cools. In other embodiments, it was found that a single heated platen is preferred (see Examples below). In some embodiments, pressure applied to a dual heat platen system is at least 40 psi, at least 45 psi, at least 50 psi, at least 60 psi, at least 70 psi, at least 80 psi, at least 90 psi, at least 100 psi, at least 110 psi, at least 120 psi. In preferred embodiments, pressure applied to a deal heat platen system is about 45 psi to about 100 psi. In more preferred embodiments, pressure applied to a dual heat platen system is about 45 psi to about 50 psi.

Systems may also be employed with the present invention that combine heating components and pressure components, and that allow for large-scale production of surface materials with fixed images. These systems include, for example, kilns, roller type assembly lines, and transfer images on rolls that are applied as the surface material passes by. Experiments conducted during development of embodiments of the present invention demonstrated that the printing methods of the present invention may be conducted for only a few seconds to obtain high quality images. Therefore, in some embodiments heated rollers are used to continuously print images into surface materials that are fed through the rollers, wherein the material need only contact the rollers for a few seconds to enable image transfer. In some such embodiments, the material fed through the rollers is preheated in a separate portion of the apparatus prior to being passed through the rollers for printing. Using such embodiments, the present invention provides methods for high throughput production of printed materials and for the printing of large sections of materials.

In some embodiments, a plurality of printing apparatuses of the present invention are provided in a single system (e.g., in a single facility) to allow high production levels of printed surface materials. In some such embodiments, two or more apparatuses or banks of apparatuses are controlled by a central control unit (e.g., a computer processor operably connected to the printing apparatuses). In some embodiments, large printing jobs (e.g., printing for architectural works) are carried out on multiple different printing devices, wherein each device is assigned a portion of the total project by the central control unit. In some embodiments, the central control unit also provides a system for labeling and/or tracking products (e.g., to facilitate shipment or delivery of products to customers). In still other embodiments, the central control unit provides, or is linked to a system that provides, order entry capabilities. For example, in some embodiments, a customer selects a pattern or provides a pattern to be printed to the central control unit and the pattern is printed into polymer materials for shipment to the customer. In some embodiments, the customer selects the pattern from a home computer or a computer in a retail store and the information is passed to the central control unit (e.g., located in a production facility) over a communication network (the Internet). Thus, the present invention allows customers to select any desired image (e.g., a digital photograph or artistic work) and transfer the image to a production facility to have the printed surface materials generated and shipped to the customer. Because the present invention provides, for the first time, the ability to print detailed, bright colored images into previously resistant surface materials, and because the present invention provides production capabilities, a new market for custom design products is created. In some preferred embodiments, many or all of the production steps are automated, allowing product ordering to product production to be carried out with little to no human intervention.

### VI. Fixed Image Characteristics

The systems and methods of the present invention allow fixed images to be transferred into surface materials with high levels of dye transfer. The resulting fixed images have novel characteristics. One of these characteristics that is conveniently measured is optical density. The fixed images of the present invention have optical densities very close to the original transfer image's optical density, as well as very high optical density values in general.

Optical density may be determined by employing, for example, a gray scale. Another method for measuring optical density is with the aid of a densitometer or other conventional methods. For example, a densitometer may be employed to directly measure the optical density of a surface material with a fixed image. Alternatively, a digital photograph of a surface material with a fixed image may be printed out and then analyzed with a densitometer.

While the human eye is a very good comparison device (it can perceive density variations and compare them to a known calibrated standard that identifies specific density levels), it however cannot assign specific numerical values to those variations. A densitometer, on the other hand, can assign numbers to the density variations the eye perceives by quantifying the amount of light that is reflected from a surface material with a fixed image formed therein. The densitometer is used to measure the light that would normally be reflected from the surface and reach the eye. A minimum of reflected light results in a high density (in other words, the sample absorbs a good deal of light).

Densitometers are routinely used for quality control in printing. Measurements in printing are primarily concerned with the primary colors of cyan, magenta, yellow and black. The light emitted by the light source consists of the three light colors of red, green, and blue. Since the proportions of these three colors are approximately equal, we perceive this light as white light. The quantity of light received by the photo diode in a densitometer is converted into electricity, and the internal electronics compare this measured current with a reference value (e.g., white). The difference obtained is the basis for calculating the absorption characteristics of the image being measured.

Color filters in the ray path of the densitometer may be used to restrict the light to the wavelengths relevant for image or portion of the image being measured. Color filters possess the property of allowing their own color to pass through and absorbing or blocking the rays of other colors.

The high quality of the fixed images of the present invention may also be evaluated by comparing the original transfer image (e.g., color print out on high quality paper) with the final fixed image in the surface material. Surprisingly, the fixed images of the present invention closely resemble the original transfer image. In order to evaluate how close the fixed image is to the original transfer image, optical density measurement of the original transfer image and the fixed image may be obtained and compared. These optical density values may be from the fixed image and transfer images themselves, or a digital image of the fixed image and the transfer image may be obtained and then compared.

Comparing the optical density values from a transfer image and a fixed image may be done as simply as subtracting one value from the other. For example, if a transfer image has an optical density value of 2.2, and a fixed image has an optical density value of 2.0, one could simply subtract 2.0 from 2.2 to obtain 0.2 as the difference between the two values (i.e., the fixed image is within 0.2 of the transfer image in this example). Another way to make a quantitative comparison between the transfer image and the fixed image is to employ software to compare digital images of each. In this regard, the high quality of the fixed images of the present invention may be quantitatively compared to an original transfer image (e.g., a transfer image prepared by the same method as the transfer image used to make the fixed image).

### EXAMPLES

### Example 1

### Forming Images in HardieBacker™

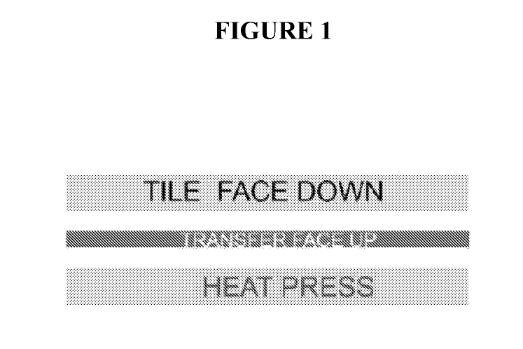

This example describes forming a fixed image on a piece of HardieBacker™ cement backerboard. A piece of HardieBacker™ cement backerboard was first primer with B-I-N (Zinsser) primer. The primed backerboard was then coated with Sher-Clear™ liquid acrylic. A transfer image was printed onto transfer paper. The transfer image was the then placed in a heat press with the backerboard tile on top of the transfer image as shown in FIG. 1. Sublimation was then conducted for five minutes at 395 degrees Fahrenheit, with about 40-45 psi of pressure. The result was an excellent image.

### Example 2

### Forming Images in HardiePanel™

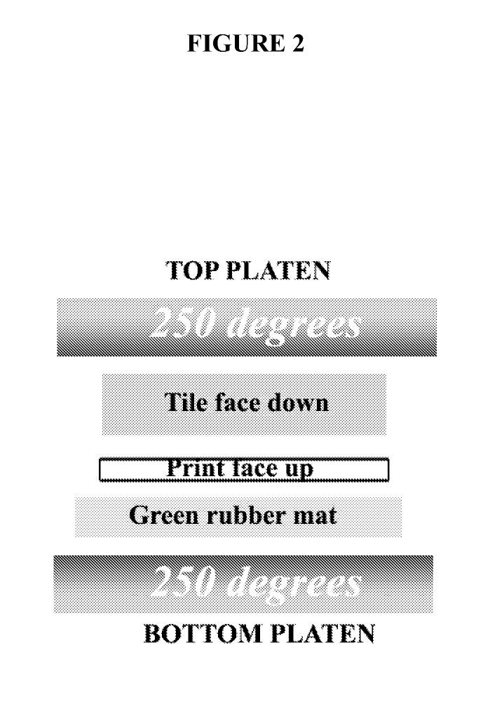

This example describes forming fixed images in Hardipanel™ vertical lap siding material using two different sublimation times. Two pieces of HardiePanel™ cement backerboard (cement fiber board) were coated with Sher-Clear™ liquid acrylic. Transfer images were printed onto transfer paper. The transfer images were the then placed in a heat press with the backerboard tile on top of the transfer images as shown in FIG. 2. For one of the samples, sublimation was then conducted at 40 pounds of pressure for five minutes at 250 degrees Fahrenheit for both the top and bottom platen. It is noted that the heat platens were both set for 250 degrees Fahrenheit, but the actual temperature was between 255-257 degrees Fahrenheit. This time gave good sublimation results. The second sample was treated the same way, except that six minutes was used for sublimation, which results in very good sublimation. For the second sample, the finished cement backerboard sample was submerged into cold water with the transfer paper still on. The transfer paper was removed after the image became visible through the back of the paper (took approximately 3-4 minutes). The paper was then removed and residue was brushed or washed off.

### Example 3

### Forming Images in HardiePanel™

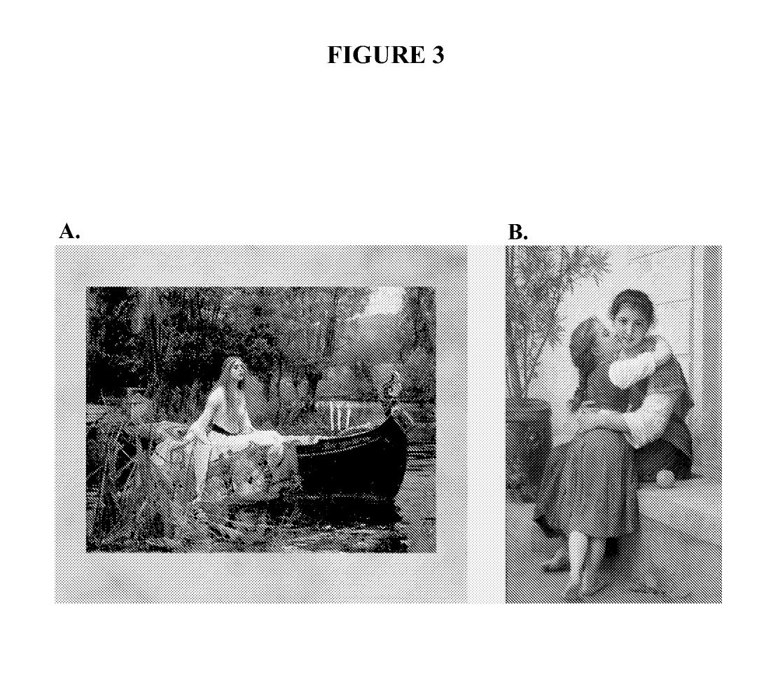

This example describes forming fixed images in Hardipanel™ vertical lap siding material. HardiePanel™ cement backerboard (cement fiber board) was sprayed with Zinsser BIN white pigmented Shellac primer-sealer. Then a top coat of Sherwin-Williman SHER-CLEAR™ acrylic clear coat was sprayed on. The transfer images were formed on BEAVER paper TexPrint XP-HR using an Epson 400 dual cmyk using subliject IQ inks. The transfer images were the then placed in a heat press for sublimation. Sublimation was carried out under 40 pounds of pressure, with the top platen set to 150 degrees Fahrenheit (actual temperature of 204 degrees Fahrenheit) and the bottom platen set to 375 degrees Fahrenheit (actual temperature of 384 degrees Fahrenheit). A green rubber heat transfer pad was employed as shown in FIG. 2. Photographs of the resulting sublimated backerboard are shown in FIGS. 3A and 3B, which shows excellent image quality.

### Example 4

### Forming Images in CertainTeed™ Fiber Cement Siding

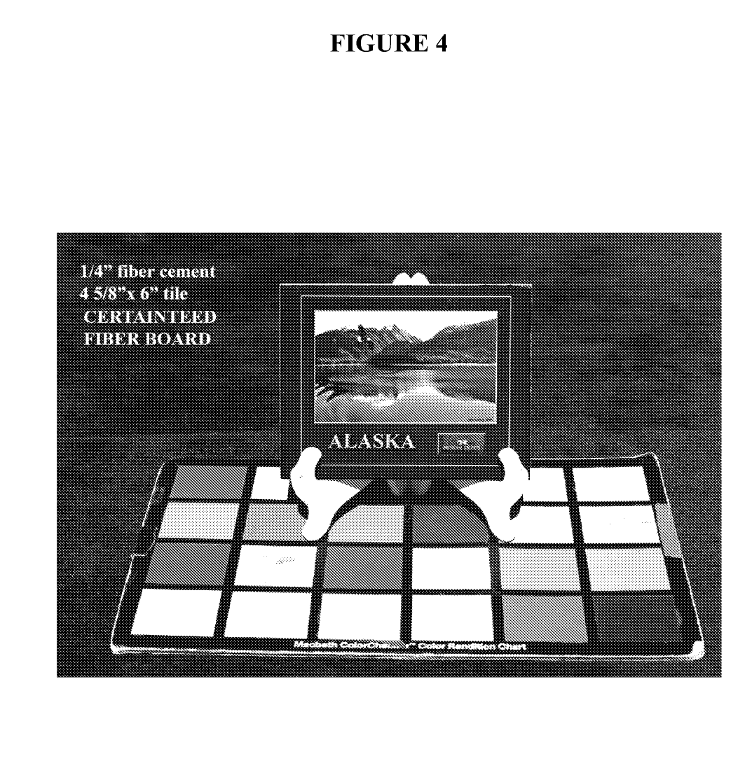

This example describes forming fixed images in Certainteed™ fiber cement siding material. A sample of CertainTeed™ fiber cement siding was obtained from the CertainTeed company with Certainteed's 100% acrylic white exterior top coat already applied. It is noted that for samples that lacked such a top coat, one could spray the fiber cement siding with a primer, such as Zinsser's red label white primer. Next, a clear liquid acrylic (Sherman-Williams Sher-Clear™) was sprayed onto the surface of the fiber cement siding. The transfer image was formed on BEAVER paper TexPrint XP-HR. The transfer image was then placed in a heat press for sublimation. Sublimation was carried out under 45 pounds of pressure, with the use of only one heat platen set at 370 degrees Fahrenheit. A green rubber 1/16 inch heat transfer pad as well as two sheets of Kraft paper were employed for this Example. In particular, the following configuration was employed starting at the bottom: 1) bottom, heated platen; 2) green silicone-rubber heat transfer pad; 3) Kraft paper; 4) sublimation paper with transfer image face up; 5) fiber cement siding sample; 6) second piece of kraft paper; and 7) top, un-heated platen. It was found that the Kraft paper was helpful in absorbing steam that resulted during the heat pressing to help ensure that the image sublimated over its entire surface. A photograph of the resulting sublimated fiber cement siding is shown in FIG. 4, which shows excellent image quality.

### Example 5

### Forming Images in CertainTeed™ Fiber Cement Siding

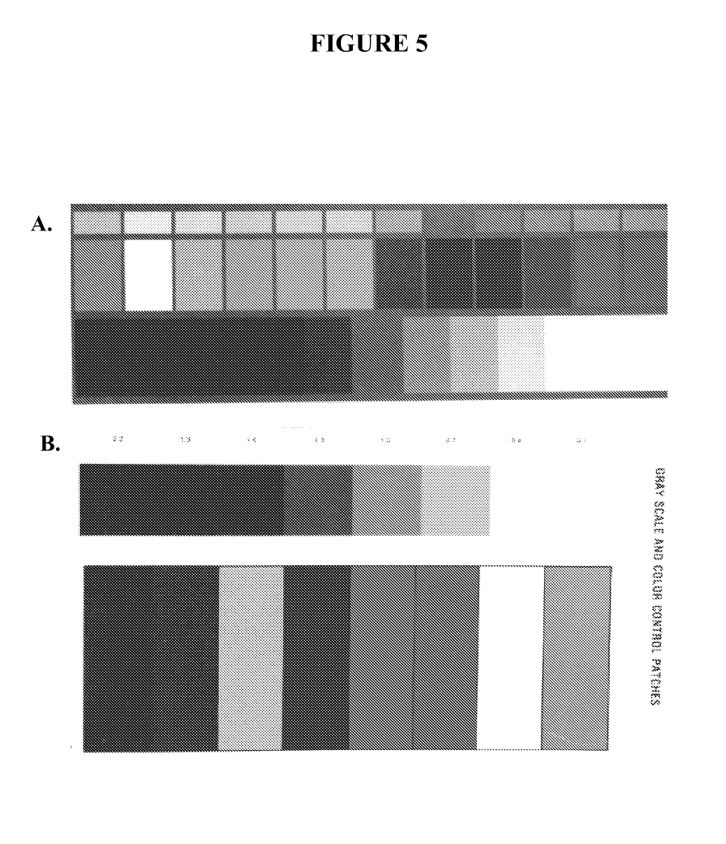

This example describes forming fixed images in Certainteed™ fiber cement siding material. A sample of CertainTeed™ fiber cement siding was obtained from the CertainTeed company with Certainteed's 100% acrylic white exterior top coat already applied. Next, a clear liquid acrylic (Sherman-Williams Sher-Clear™) was sprayed onto the surface of the fiber cement siding (three coats were applied). The transfer image, a color control panel, was formed on BEAVER paper TexPrint XP-HR. The transfer image was then placed in a heat press for sublimation. Sublimation was carried out under 45 pounds of pressure for 5 minutes with the use of only one heat platen set at 370 degrees Fahrenheit. A green rubber 1/16 inch heat transfer pad as well as two sheets of Kraft paper were employed for this Example. In particular, the following configuration was employed starting at the bottom: 1) bottom, heated platen; 2) green silicone-rubber heat transfer pad; 3) Kraft paper; 4) sublimation paper with transfer image face up; 5) fiber cement siding sample; 6) second piece of kraft paper; and 7) top, un-heated platen. It was found that the Kraft paper was helpful in absorbing steam that resulted during the heat pressing to help ensure that the image sublimated over its entire surface. A photograph of the resulting sublimated fiber cement siding is shown in FIG. 5A. The tile was photographed next to a color control panel (FIG. 5B) to show the close OD correspondence between the resulting image in the tile and a color control panel.

### Example 6

### Comparing Resulting Images with Original Transfer Image

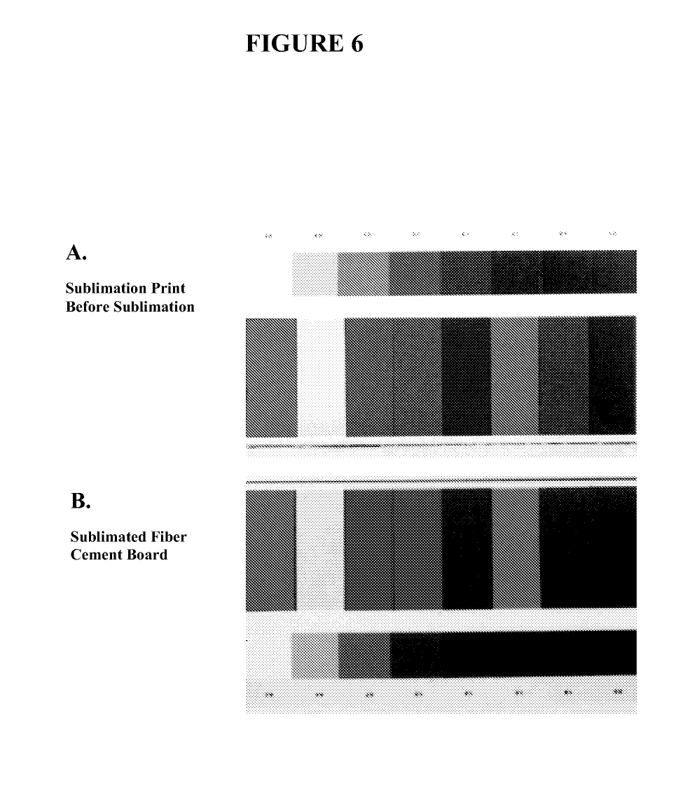

This example describes forming fixed images in Certainteed™ fiber cement siding material and comparing the resulting image to the original transfer paper image. A sample of CertainTeed™ fiber cement siding was obtained from the CertainTeed company with Certainteed's 100% acrylic white exterior top coat already applied. Next, a clear liquid acrylic (Sherman-Williams Sher-Clear™) was sprayed onto the surface of the fiber cement siding (three coats were applied). The transfer image, a color control panel, was formed on BEAVER paper TexPrint XP-HR. A second, duplicate transfer image was made at the same time for comparison purposes. The transfer image was then placed in a heat press for sublimation. Sublimation was carried out under 45 pounds of pressure for 5 minutes with the use of only one heat platen set at 370 degrees Fahrenheit. A green rubber 1/16 inch heat transfer pad as well as two sheets of Kraft paper were employed for this Example. In particular, the following configuration was employed starting at the bottom: 1) bottom, heated platen; 2) green silicone-rubber heat transfer pad; 3) Kraft paper; 4) sublimation paper with transfer image face up; 5) fiber cement siding sample; 6) second piece of kraft paper; and 7) top, un-heated platen. It was found that the Kraft paper was helpful in absorbing steam that resulted during the heat pressing to help ensure that the image sublimated over its entire surface. A photograph of the resulting sublimated fiber cement siding is shown in FIG. 6B. The tile was photographed next to the second transfer image that was made but not used (shown in FIG. 6A). A comparison between the tile in FIG. 6B and the unused transfer image in FIG. 6A shows that transfer method allows for a nearly identical image quality to be sublimated into the fiber cement board. This comparison shows that the OD of the resulting image in the fiber cement board is very close the the original transfer image.

### Example 7

### Forming Images in CertainTeed™ Fiber Cement Siding with Different Numbers of Coats of Clear Acrylic

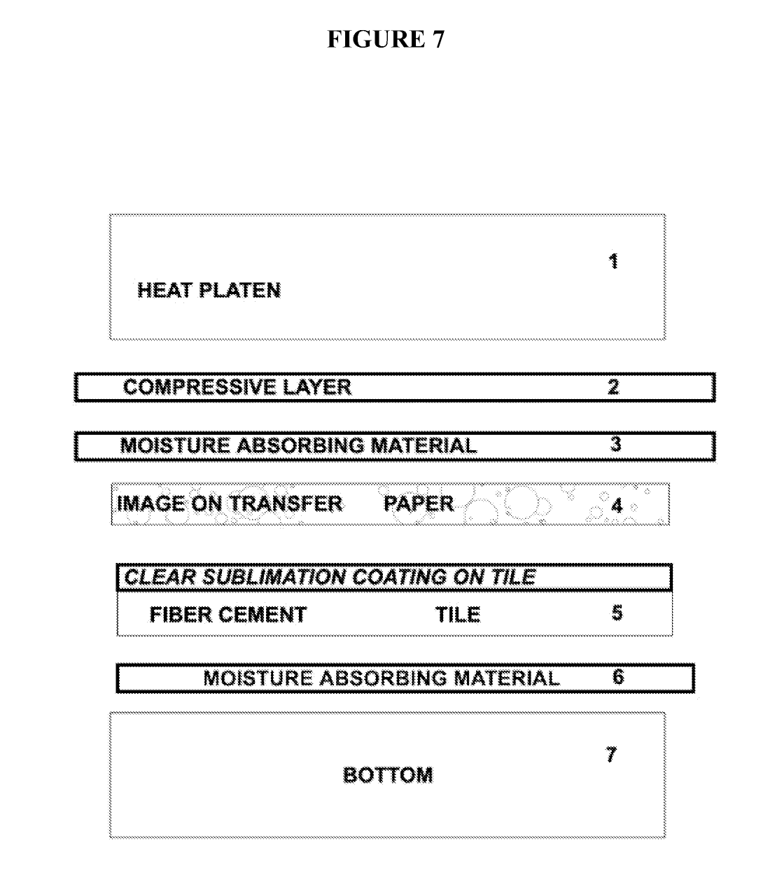

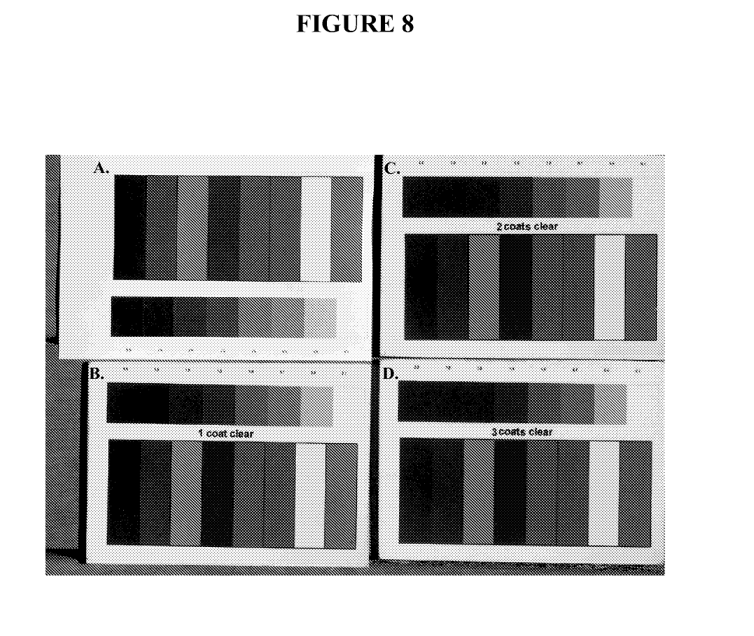

This example describes forming fixed images in Certainteed™ fiber cement siding material using either one, two, or three coats of liquid acrylic. A sample of CertainTeed™ fiber cement siding was obtained from the CertainTeed company with Certainteed's 100% acrylic white exterior top coat already applied. Next, either one, two, or three coats of clear liquid acrylic (Sherman-Williams Sher-Clear™) was sprayed onto the surface of the fiber cement siding. The transfer image, a color control panel, was formed on BEAVER paper TexPrint XP-HR. The transfer image was photographed before use and is shown in FIG. 8A. The transfer image was then placed in a heat press for sublimation. Sublimation was carried out under 45 pounds of pressure for 5 minutes with the use of only one heat platen set at 370 degrees Fahrenheit. A green rubber 1/16 inch heat transfer pad as well as two sheets of Kraft paper were employed for this Example. In particular, the following configuration, shown in FIG. 7, was employed starting at the top: 1) top, heated platen; 2) green silicone-rubber heat transfer pad; 3) Kraft paper; 4) sublimation paper with transfer image face down; 5) fiber cement siding sample with clear coat face up; 6) second piece of kraft paper; and 7) bottom, un-heated platen. It was found that the Kraft paper was helpful in absorbing steam that resulted during the heat pressing to help ensure that the image sublimated over its entire surface. Photographs of the resulting sublimated fiber cement siding samples are shown in FIG. 8B (one coat of clear acrylic), FIG. 8C (two coats of clear acrylic), and FIG. 8D (three coats of clear acrylic). The three finished tiles were photographed next to the transfer image prior to use (in FIG. 8A) to show the close OD correspondence between the resulting image in the tiles and the color control panel.

### Example 8

### Forming Images on Wood

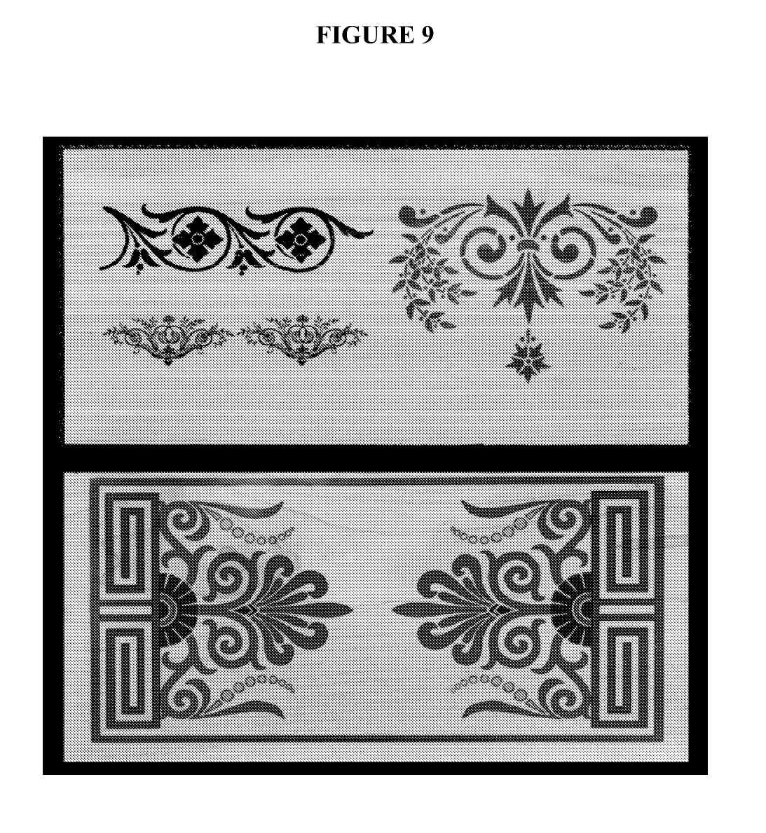

This example describes forming fixed images on a wood. Three coats of a clear liquid acrylic (Sherman-Williams Sher-Clear™) was sprayed onto the surface of the wood. The transfer image was formed on BEAVER paper TexPrint XP-HR. The transfer image was then placed in a heat press for sublimation. Sublimation was carried out about 45 pounds of pressure for 4.5-5 minutes with the use of a heat press at 370 degrees Fahrenheit. A photograph of the results of the sublimation are shown in FIG. 9.

All publications and patents mentioned in the above specification are herein incorporated by reference. Various modifications and variations of the described method and system of the invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention that are obvious to those skilled in relevant fields are intended to be within the scope of the following claims.

1. A method for printing an image onto a surface material, comprising:
a) providing:
i) cement fiber board material comprising a surface; and
ii) a transfer medium comprising a transfer image,
b) coating said surface of said cement fiber board material with a clear acrylic resin to create a clear acrylic resin layer on said surface, and
c) contacting said clear acrylic resin layer with said transfer medium such that a fixed image is formed in said clear acrylic resin layer to create a printed surface on said cement fiber board material.

2. The method of claim 1, further comprising, prior to step b), a step of coating said surface of said cement fiber board material with an opaque primer.

3. The method of claim 2, wherein said opaque primer is a heat-stable primer able to withstand temperatures of between 230 and 390 degrees Fahrenheit without bubbling.

4. The method of claim 1, further provide a top plate and a bottom plate, and wherein said contacting is conducted under pressure between said top plate and said bottom plate.

5. The method of claim 4, further providing a compressible layer, wherein said compressible layer is situated between said top plate and said bottom plate.

6. The method of claim 5, wherein said compressible layer is in contact with said transfer medium.

7. The method of claim 4, further providing at least one moisture absorbing layer, wherein said at least one moisture absorbing layer is situated between said top plate and said bottom plate.

8. The method of claim 4, further providing a compressible layer and at least one moisture absorbing layer, wherein said compressible layer and said at least one moisture absorbing layer are situated between said top plate and said bottom plate.

9. The method of claim 1, wherein said clear acrylic resin is applied as a liquid.

10. The method of claim 1, further comprising, prior to step b), the step of sanding said fiber cement board material.

11. The method of claim 1, wherein said transfer medium comprises clay.

12. The method of claim 1, wherein said contacting is conducted at temperature of at least 200 degrees Fahrenheit.

13. A composition comprising:
a) cement fiber board material comprising a surface,
b) a clear acrylic resin layer on said surface of said cement fiber board; and
c) a fixed image, wherein said fixed image is formed in said clear acrylic resin layer, and wherein said fixed image has: i) a fixed image optical density value within about 1.5 of a corresponding transfer image optical density value; or ii) a fixed image optical density value of at least 0.7.

14. The composition of claim 1, wherein said surface of said cement fiber board material is coated with an opaque primer.

15. A composition comprising:
a) cement fiber board material comprising a surface coated with an opaque primer, and
b) a clear acrylic resin layer on said surface of said cement fiber board, wherein said clear acrylic resin layer is configured to receive a fixed image via sublimation.

16-22. (canceled)
